(19) United States
(12) Patent Application Publication
(10) Pub. No.: US 2013/0159259 A1
(43) Pub. Date: Jun. 20, 2013

(54) Providing Feedback Regarding Validity of Data Referenced in a Report

(71) Applicant: Godfrey Hobbs, Vancouver (CA)

(72) Inventor: Godfrey Hobbs, Vancouver (CA)

(73) Assignee: Business Objects Software Ltd., Dublin 1 (IE)

(21) Appl. No.: 13/329,778

(22) Filed: Dec. 19, 2011

(51) Int. Cl. G06F 17/30

(52) U.S. Cl. 707/690; 707/E17.001; 707/E17.005

(57) ABSTRACT

In an embodiment, a method is provided for providing feedback regarding validity of data referenced in a report. In this method, the report is accessed, and this report references data stored in a data source separate from the report. A profile of metadata associated with referencing the data source is read from the report, and this profile is verified against a current state of the data source. A mismatch is detected based on the verification and a digital watermark is added to a rendering of the report. This digital watermark informs the mismatch associated with the referenced data.

### FIELD

The present disclosure relates generally to data verification. In an embodiment, the disclosure relates to providing feedback regarding validity of data referenced in a report.

### BACKGROUND

Many users use report generation applications to design and generate reports from a wide range of data sources. For example, such report generation applications can be used to design data connections, filters, formulas, and report layout. Particularly, users can use the report generation applications to select and link tables from a wide variety of data sources, such as spreadsheets and databases. Users can then place the referenced fields from these tables on the report.

In running such reports, semantic errors often occur when referencing the data stored on the data sources. A type of semantic error is a mismatch that is due to modification of the data source after the report is created. For example, the report may reference a particular column in a database table that is no longer available. However, many of these mismatches are non-fatal because, although the data generated may not be correct, such mismatches will not crash the report generation applications. For example a report with a Structured Query Language (SQL) based data source may not receive an SQL exception after a data mismatch although the data returned may no longer express the report writer's intent. In contrast to a semantic error, a fatal error would be an example of an SQL exception where it becomes impossible to render any part of the report. Different report generation applications take different approaches of dealing with data source mismatches. A single application may run in many modes, design mode, viewing mode, or batch (headless) mode, and different approaches can be taken to deal with data source mismatches in different modes. For example, in design mode, the approach of dealing with data source mismatches may be with pop-up error messages. However, in batch/headless mode, the approach of dealing with data source mismatches with pop-up error messages is not possible. Therefore, in batch/headless mode, the approach of dealing with data source mismatches is often to silently attempt to recover without informing the report consumer. For a variety of purposes including user experience, many of these conventional report generation applications are designed to silently recover from such semantic errors.

### BRIEF DESCRIPTION OF DRAWINGS

The present disclosure is illustrated by way of example and not limitation in the figures of the accompanying drawings, in which like references indicate similar elements and in which:

FIG. 1 is a diagram depicting a graphical representation of a report that includes feedback regarding the validity of referenced data, in accordance with an example embodiment;

FIG. 2 is a block diagram of a report module, in accordance with an example embodiment, that provides feedback regarding the validity of data referenced in a report;

FIG. 3 is a flow diagram depicting a general overview of a method, in accordance with an example embodiment, for providing feedback regarding the validity of data referenced in a report;

FIG. 4 is a flow diagram of a detailed method, in accordance with an alternate embodiment, for providing feedback regarding the validity of data referenced in a report;

FIG. 5 is a diagram depicting an example of a rendered report that references data stored on a separate data source;

FIG. 6 is a diagram depicting a change of a table's name;

FIG. 7 is a diagram depicting the results of the table name change on the example of the rendered report;

FIG. 8 is a diagram depicting a report that provides feedback regarding the validity of data referenced in the report, in accordance with an example embodiment; and

FIG. 9 depicts a block diagram of a machine in the example form of a computing device within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

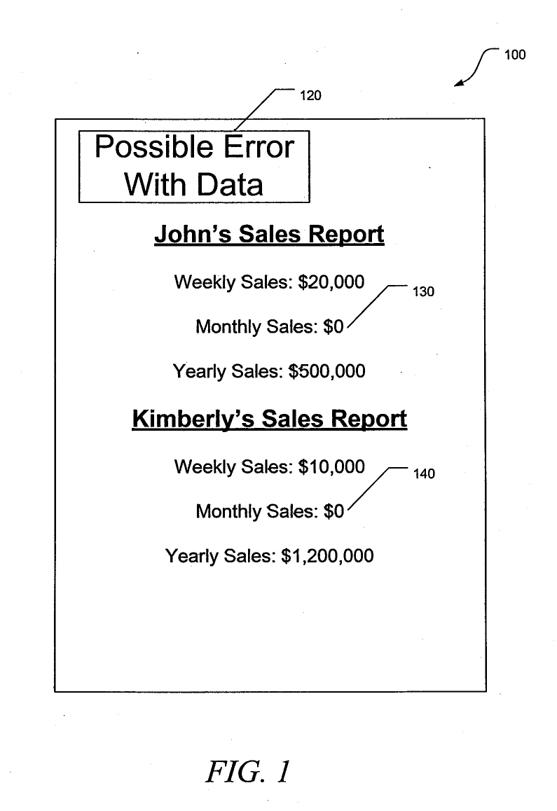

FIG. 1 is a diagram depicting a graphical representation of a report 100 that includes feedback regarding the validity of referenced data, in accordance with an example embodiment. As used herein, a “report” refers to a document including information automatically retrieved (e.g., in response to computer executable instructions) from a data source (e.g., a database, a data warehouse, semi-structured data source, spreadsheet, and the like), where the information is structured and formatted in accordance with a report schema that specifies the form in which the information should be presented. An example of a report 100 includes a single or multiple files that are accessible by and/or associated with electronic report processing applications such as word processing applications, report viewers, email applications, presentation applications, spreadsheet applications, diagramming applications, graphic editors, graphic viewers, enterprise applications, and other applications. Therefore, as explained in more detail below, the report 100 may be composed of alphanumeric texts, symbols, images, videos, sounds, and other data. It should be appreciated that the report 100 can have a variety of file formats that, for example, may be identified by data within the report 100 and/or by the filename extension. Examples of file formats that may be associated with report 100 include Adobe Portable Document Format (PDF), Microsoft DOC format, Hypertext Markup Language (HTML) format, Extensible Markup Language (XML) format, Microsoft XLS format, Crystal Reports® Report File Format (RPT), Tag Image File Format (TIFF), Rich Text Format (RTF), Tag Image File Format (TIFF), and SAP® BusinessObjects™ Web Intelligence (WID).

As depicted in FIG. 1, the report 100 includes various sales data. For example, John's weekly sales is $20,000 while Kimberly's weekly sales is $10,000. These sales data are actually stored separately from the report 100. In particular, the sales data are stored in a data source that is located separate from the report 100. A “data source,” as used herein, refers to a facility for storing and querying of data. Such a data source includes one or more data structures that provide context for the organization of data. Examples of data structures include tables, arrays, linked lists, databases, and other data structures. In one example, the data source can be located on a central server that is accessible by way of a computer network. In another example, the data source can be stored on the same computing device as the report, but the data source is stored as a separate file from the report file.

When the report 100 is opened, an application that provides a rendering of the report 100 extracts the data from the data source and inserts the data into the report 100. Accordingly, the data included in the report 100 is dynamic. For example, if the sales data change in the data source, then the sales data as referenced in the report 100 are also updated accordingly the next time the report is refreshed, viewed, or the like.

The data referenced by the report 100 can be erroneous due to an update to the structure of the data source after the report has been authored. For example, in reference to FIG. 1, database tables that store the monthly sales data for John and Kimberly. The relevant tables may have been modified such that their monthly sales data are no longer available. The application has no way of getting the correct monthly sales data from the datasource. Therefore, as depicted, the report may be rendered with a $0 for John's monthly sales 130 and $0 Kimberly's monthly sales 140. The non-availability of such sales data may not always cause a fatal error, and thus, many traditional report viewer modes proceed to display the report 100 without any indication that there is a mismatch with the displayed data and the report authors' original intent. This is an example of a semantic error. As explained in more detail below, embodiments of the present invention can detect an mismatch associated with the data stored at the data source and, as depicted in FIG. 1, add a notification 120 to a rendering of the report 100 to notify a user that there is mismatch and possibly a semantic error with the displayed data.

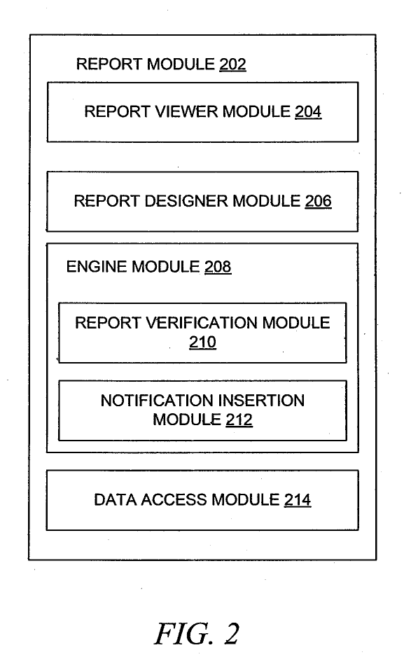

FIG. 2 is a block diagram of a report module 202, in accordance with an example embodiment, that provides feedback regarding the validity of data referenced in a report. As explained in detail below, data is “valid” if it is free from mismatches. It should be appreciated that the report module 202 may be deployed within, for example, a computer, a tablet computer, a personal digital assistant, a cellular phone, or other computing devices. In various embodiments, the report module 202 may be used to implement computer programs, logic, applications, methods, processes, or software to provide feedback regarding the validity of data, as described in more detail below.

In general, the report module 202 is configured to generate and provide a rendering and exporting of reports. Different headless modes where, a pop-up warning is not possible, include batch printing and exporting as email attachments, uploading to file repositories, and the like. The reports may also be personalized for each target recipient as would be the case for a monthly utility bill. Examples of report module 202 include a report design application, a word processing application, a spreadsheet application, and a presentation application. As depicted, the report module 202 includes a report viewer module 204, a report designer module 206, an engine module 208, and a data access module 214. The report designer module 206 is configured to generate a report and to provide various tools to modify the report. The report viewer module 204 is configured to generate a rendering of the report for viewing, exporting, and/or printing. The data access module 214 is configured to access data referenced in the report from one or more external data sources.

The engine module 208, in general, accesses the referenced data by way of the data access module 214 and provides a rendering of the report with the referenced data by way of the report viewer module 204. In this embodiment, the report designer module 206 includes a report data source verification module 210 and a notification insertion module 212. As explained in detail below, the report data source verification module 210 is configured to verify the data source referenced by the report. As also explained in more detail, the notification insertion module 212 is configured to add a notification regarding feedback from the report data source verification module 210.

It should be appreciated that in other embodiments, the report module 202 may include fewer or more modules apart from those shown in FIG. 2. For example, in an alternate embodiment, the report data source verification module 210 can be integrated together with the notification insertion module 212. The modules 202, 204, 206, 208, 210, 212, and 214 may be in the form of software that is processed by a processor. In another example, as explained in more detail below, the modules 202, 204, 206, 208, 210, 212, and 214 may be in the form of firmware that is processed by application specific integrated circuits (ASIC), which may be integrated into a circuit board. Alternatively, the modules 202, 204, 206, 208, 210, 212, and 214 may be in the form of one or more logic blocks included in a programmable logic device (e.g., a field programmable gate array). The described modules 202, 204, 206, 208, 210, 212, and 214 may be adopted, and/or additional structures may be provided, to provide alternative or additional functionalities beyond those specifically discussed in reference to FIG. 2. Examples of such alternative or additional functionalities will be discussed in reference to the flow diagrams discussed below.

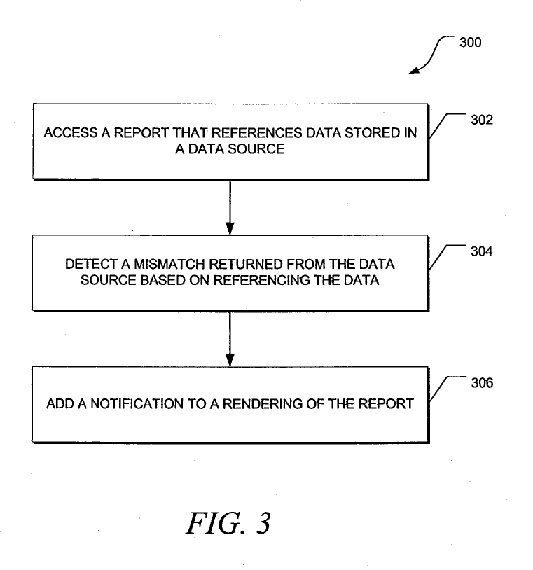

FIG. 3 is a flow diagram depicting a general overview of a method 300, in accordance with an example embodiment, for providing feedback regarding the semantic validity of the data presented in the report. In an example embodiment, the method 300 may be implemented by the report data source verification module 210 and the notification insertion module 212 described in FIG. 2.

Referring to FIG. 3, the report data source verification module, at 302, initially accesses a report that references data stored in a data source that is separate from the report. After the report has been accessed, the report data source verification module, at 304, detects a mismatch returned from the data source when referencing the data. As explained in more detail below, such an mismatch can come to light via a Structured Query Language (SQL) exception. Upon detection of the mismatch, the notification insertion module then, at 306, adds a notification to a rendering of the report. It should be noted that the notification can comprise a variety of graphical representations. As an example, the notification can be embodied as a digital watermark, which is a visible image or text that is displayed with the contents of the report. The watermark can be faintly to strongly visible depending on configuration and may underlie or overlie some of the contents of the report. In another embodiment, the notification can be a message box displayed along with the contents of the report.

In should be appreciated that the notification is not added to the report file. That is, the report file is not modified to accommodate the notification. Instead, the notification is added to a rendering of the report. For example, the notification can be embedded into a digital signal used in the rendering of the report. In another example, the notification can be added to a memory representation of the report. In particular, a report viewer module can instruct a computing device to load the report file into its volatile memory, and the report viewer module can then render a visual or graphical representation of the report on a video display based on the representation stored in the volatile memory. The notification insertion module can insert the notification while the report file is loaded in the volatile memory. In addition, the rendering of the report can be transmitted to a printer to be printed on paper or other media, and/or exported to a file. For example, the renderings can be transmitted to a printer for batch printing where multiple reports are printed in one print job.

The addition of such a notification may possibly make workflows that rely on data referenced in a report more reliable and accurate. For example, after a report has been created, the report may be refreshed many times to display valid data. However, if a database that stores the data changes and results in a mismatch, the methodologies described herein injects a notification (e.g., a watermark) to the report. This notification can call into question the validity of the data presented. The warning provided by such a notification can prompt a user to examine and fix potential errors in referencing the data. This notification may also have the contact information, email or phone number of the data source maintainer. This helps prompt the user to communicate the mismatch to the report designer or the maintainer of the data source. For instance, the user may need to file a ticket or write up bug description for a database administrator or other information technology professional.

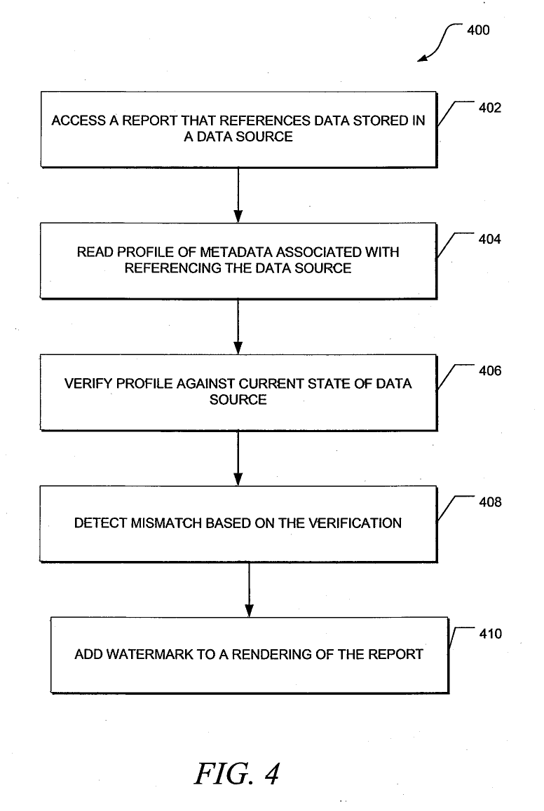

FIG. 4 is a flow diagram of a detailed method 400, in accordance with an alternate embodiment, for providing feedback regarding the validity of data referenced in a report. In an example embodiment, the method 400 may be implemented by the report data source verification module 210 and the notification insertion module 212 described in FIG. 2.

In reference to FIG. 4, the report data source verification module, at 402, accesses a report that references data stored in a data source that is separate from the report. The report data source verification module then, at 404, reads a profile of various metadata associated with referencing the data source from the report. As used herein, a “profile” refers to a snapshot of the metadata. Examples of metadata include names of database views, names of database tables, names of spreadsheets, names of columns, names of result objects such as measures and dimensions from a semantic layer that overlies the data source, SQL statements, data parameters, localized names for any of these data source elements, and other metadata.

At 406, the report data source verification module then verifies the read profile against a current state of the data source. The current “state” of the data source refers to the current attributes of the data source. Examples of attributes include information regarding one or more of a database table, database view, SAP BusinessObjects Universe, SAP BEx query, stored procedure, file, and other attributes. This includes the example when the above-mentioned information may be localized.

The verification at 406 is to determine whether there is a mismatch in referencing the data stored in the data source. The mismatch is expressed via the verify data source feedback. There are a variety of different verification techniques. For example, the profile can include a reference to a database table, and the verification feedback can include a message that the referenced database table has been dropped from the data source. If such a database table is made non-existent verification feedback will be generated. In another example, the profile may include a reference to a data parameter, and the verification feedback can include a message that the referenced data parameter has been dropped from the data source. A “data parameter,” as used herein, refers to a prompt consumed by a data source. In another example, the profile may include a reference to a data source field (or Result Object), and the verification feedback can include a message that the referenced field objects have been dropped from the data source. In another example, the profile may include a reference to a data source field, and the verification feedback can include a message that the referenced data field's type has been changed. For example, a field type may have change from currency to number or from string[20] to string[254]. In a further example, the profile can include a reference to one or more secondary reports, each of which herein referred to as a “subreport,” and the verification can include detecting whether the referenced subrcports are not longer linked to the main report. If these subreports have become unlinked, verification feedback may be returned. In yet another example, the profile can include a referenced measure with an aggregate value, which is generated by the measure's aggregation function defined in the data source. A measure's aggregate function is a function where the values of multiple rows are grouped together as input on certain criteria to form a single value. The verification can include detecting whether a measure's aggregation function that generates the referenced aggregate value has been changed at the data source. For example, a report may have been created to refer to measure whose aggregate values are generated by a particular aggregate function, such as “sum.” If this measure's aggregate function is modified to a different function such as “count,” then the generated aggregate values may also change, thereby triggering verification feedback representing this mismatch.

Referring now to 408, the report data source verification module may detect a mismatch based on verification. If a mismatch is detected, the notification insertion module can add a digital watermark to a rendering of the report at 410. As discussed above, this digital watermark informs an mismatch (and possible semantic error) associated with the referenced data.

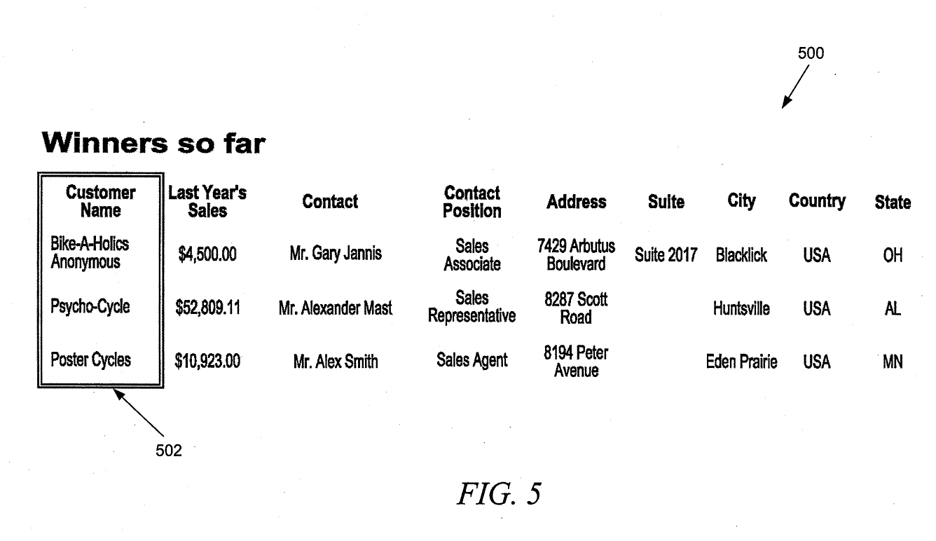

FIG. 5 is a diagram depicting an example of a rendered report 500 that references data stored on a separate data source. As depicted, the report 500 is in the form of a report that lists a number of customers who are winners in a sweepstake contest. In this example, the winning customer names 502 are added to the report daily. In particular, this data referenced in the report 500 is compiled from joining two different database tables, the SQL statements of which are expressed in the following Table A:

TABLE A

```
Winners Table:
  CREATE TABLE [dbo].[Winners](
  [Code] [nvarchar](20) NULL,
  [Discount] [money] NULL,
  [Customer ID] [int] NULL
  ) ON [PRIMARY]
Customer Table:
  CREATE TABLE [dbo].[Customer](
  [Customer ID] [int] NOT NULL,
  [Customer Credit ID] [int] NULL,
  [Customer Name] [nvarchar](40) NULL,
  [Contact First Name] [nvarchar](30) NULL,
  [Contact Last Name] [nvarchar](30) NULL,
  . . .
  ) ON [PRIMARY]
```

As described in Table A, the two database tables are named “Winners” and “Customer.” The winning customer names 502 are created with the following table join SQL statements:
[Customer.Customer ID]<->[Winners.Customer ID]
   As a result of this SQL inner join, the report 500 will not have more rows than the “Winners” table. Whenever an existing customer becomes a winner, a new record will be added to the “Winners” table.

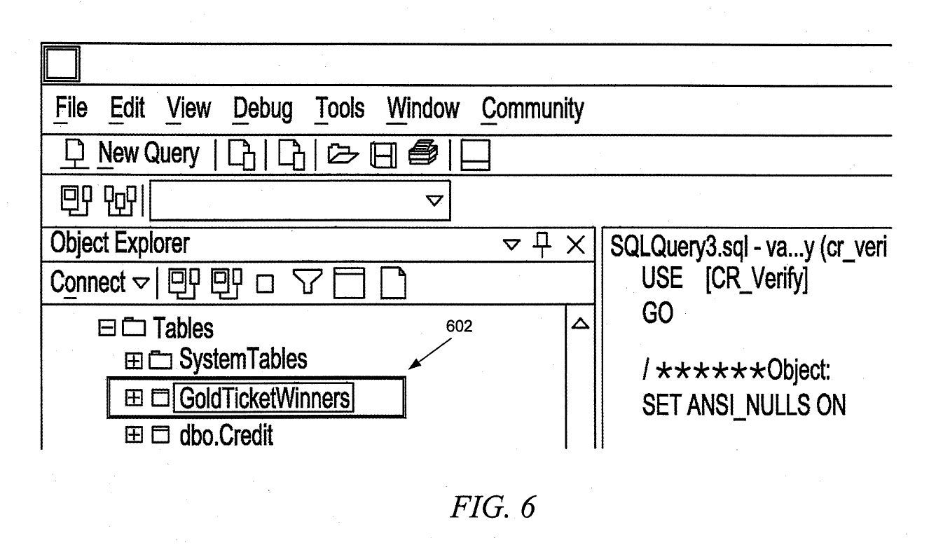

After the report has been created, a request is made to change the name of the “Winners” table to “GoldTicketWinners” table. As depicted in FIG. 6, a user can use a database management application to change the name of a table from “Winners” to “GoldTicketWinners” 602.

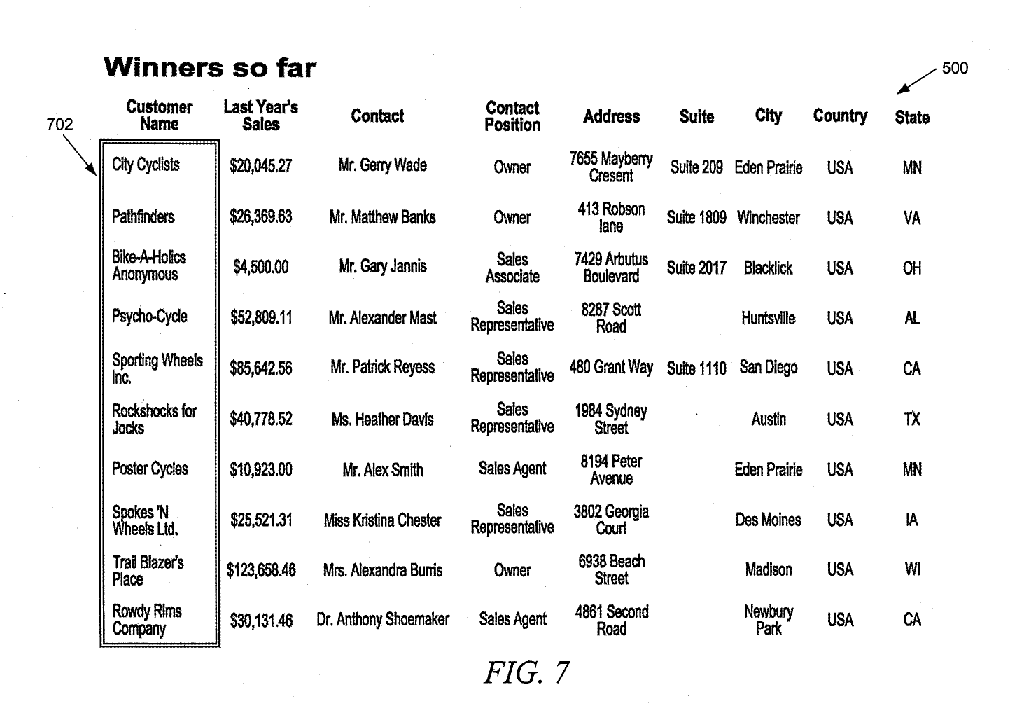

FIG. 7 is a diagram depicting the results of the name change on the example of the rendered report 500. As a result of this name changing from “Winners” to “GoldTicketWinners,” the Report's list of winning customer names 702 also changes. In particular, instead of a handful of winners, the report 500 now shows many winning customer names 702. A semantic error has occurred due to the data source mismatch. This new list of winning customer names 702 is erroneous because when the “Winners” table is dropped as a result of the renaming, the inner join constraint, which is depicted above as statement (1), is no longer enforced. Particularly, this “Winners” table is marked as missing and all the fields from the missing “Winners” table are dropped from the report 500. The application does a best guess at rewriting the SQL query statement. The rewriting of the SQL query removes all mention of the “Winners” table. This rewriting includes removing the inner join constraint. Furthermore, all report objects and join links from the “Winner” table are removed from the report definition. As a result, the inner join constraint is dropped from the report 500.

As a result of the mismatch and ensuing SQL query statement updates, the report 500 incorrectly shows the entire “Customer” table, thereby listing all Customers as winners in the sweepstake contest. However, a user who does not have knowledge of the name change and does not expect that the data will be modified from the name change can view the report 500 without knowing that there is an mismatch with the underlying data. This is an example of a semantic error.

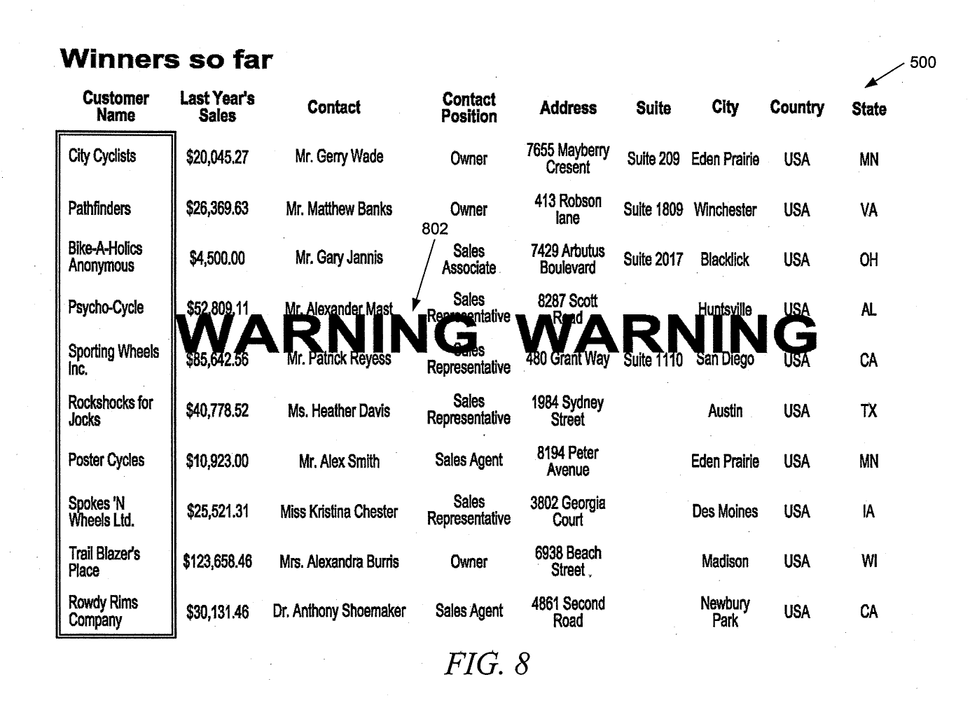

FIG. 8 is a diagram depicting a report 500 that provides feedback regarding the mismatch of data referenced in the report 500, in accordance with an example embodiment. In view of the techniques described, embodiments of the present invention can detect a mismatch associated with the referenced data and add a digital watermark 802 to a rendering of the report 500 to inform a user that there might be a mismatch and, in this example, a real semantic error associated with the referenced data.

In particular, in verifying the data source, the report data source verification module would encounter the mismatch due to the missing “Winners” table. As a result, a notification insertion module adds the digital watermark “WARNING WARNING” 802 to the report 500. Such a digital watermark 802 will warn a user viewing the report 500 that there might be errors associated with the referenced data. Upon seeing such a digital watermark 802, the user can debug the source of the error such that the report 500 references correct data. The user can also ask for help from the maintainer of the data source or the report designer.

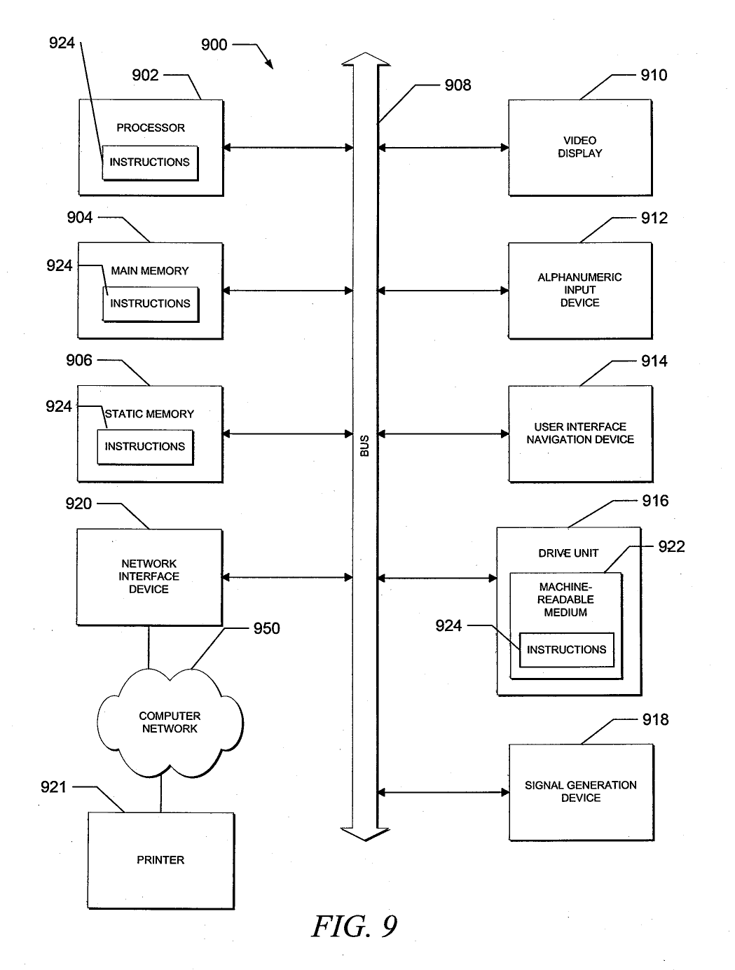

FIG. 9 depicts a block diagram of a machine in the example form of a computing device 900 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computing device 900 includes a processor 902 (e.g., a central processing unit (CPU), a graphics processing unit (GPU) or both), a main memory 904 (e.g., random access memory), and static memory 906 (e.g., static random-access memory), which communicate with each other via bus 908. The computing device 900 may further include video display unit 910 (e.g., a plasma display, a liquid crystal display (LCD) or a cathode ray tube (CRT)). The computing device 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 (a type of non-volatile storage) includes a machine-readable medium 922 on which is stored one or more sets of data structures and computer executable instructions 924 (e.g., software) embodying or utilized by any one or more of the methodologies or functions described herein. The data structures and instructions 924 may also reside, completely or at least partially, within the main memory 904 and/or within the processor 902 during execution thereof by computing device 900, with the main memory 904 and processor 902 also constituting machine-readable, tangible media.

The data structures and instructions 924 may further be transmitted or received over a computer network 950 via network interface device 920 utilizing any one of a number of well-known transfer protocols (e.g., HyperText Transfer Protocol (HTTP)). As also depicted FIG. 9, data structures and instructions 924 can be communicated to a printer 921, which is a device that prints renderings of reports on paper.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the computing device 900) or one or more hardware modules of a computer system (e.g., a processor 902 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 902 configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine, but deployed across a number of machines. In some example embodiments, the processors 902 may be located in a single location (e.g., within a home environment, an office environment or as a server farm), while in other embodiments the processors 902 may be distributed across a number of locations.

While the embodiment(s) is (are) described with reference to various implementations and exploitations, it will be understood that these embodiments are illustrative and that the scope of the embodiment(s) is not limited to them. In general, techniques providing feedback regarding validity of data referenced in a report may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method of providing feedback regarding validity of data as presented in a report, the method comprising:
accessing the report that references the data stored in a data source separate from the report;
reading, from the report, a profile of metadata associated with referencing the data source;
verifying the profile against a current state of the data source;
detecting a mismatch based on the verification; and
adding a digital watermark to a rendering of the report, the digital watermark informing the mismatch associated with the referenced data.

2. The method of claim 1, wherein the profile includes a referenced database table, and wherein the verification comprises detecting that the referenced database table has been dropped from the data source.

3. The method of claim 1, wherein the profile includes a referenced data parameter, and wherein the verification comprises detecting that the referenced data parameter has been dropped from the data source.

4. The method of claim 1, wherein the profile includes a referenced subreport, and wherein the verification comprises detecting that the referenced subreport has become unlinked from the report.

5. The method of claim 1, wherein the profile includes a referenced aggregate value, and wherein the verification comprises detecting that an aggregate function that generates the referenced aggregate value has been changed at the data source.

6. The method of claim 1, further comprising transmitting the rendering to a printer.

7. The method of claim 1, wherein the rendering is displayed on a video display.

8. The method of claim 1, further comprising exporting the rendering to a file.

9. The method of claim 1, wherein the mismatch is associated with a semantic error.

10. A non-transitory, machine-readable medium that stores instructions, which, when performed by a machine, cause the machine to perform operations comprising:
accessing a report that references data stored in a data source separate from the report;
reading, from the report, a profile of metadata associated with referencing the data source;
verifying the profile against a current state of the data source;
detecting a mismatch based on the verification; and
adding a notification to a rendering of the report, the notification informing the mismatch associated with the referenced data.

11. The non-transitory, machine-readable medium of claim 10, wherein the notification is added to a memory representation of the report.

12. The non-transitory, machine-readable medium of claim 10, wherein the profile includes a referenced database table, and wherein the operation of verifying the profile comprises detecting that the referenced database table has been dropped from the data source.

13. The non-transitory, machine-readable medium of claim 10, wherein the profile includes a referenced data field, and wherein the operation of verifying the profile comprises detecting that the referenced data field has been dropped from the data source.

14. The non-transitory, machine-readable medium of claim 10, wherein the profile includes a referenced data parameter, and wherein the operation of verifying the profile comprises detecting that the referenced data parameter has been dropped from the data source.

15. A system comprising:
a data source verification module having instructions that when executed by at least one processor, cause operations to be performed, the operations comprising:
accessing a report that references data stored in a data source separate from the report; and
detecting a mismatch returned from the data source based on referencing the data; and
a notification insertion module having instructions that when executed by at least one processor, cause operations to be performed, the operations comprising adding a notification to a rendering of the report, the notification informing the mismatch associated with the referenced data.

16. The system of claim 15, wherein the operation of detecting the mismatch comprises:
reading, from the report, a profile of metadata associated with referencing the data source;
verifying the profile against a current state of the data source; and
generating the mismatch based on the verification.

17. The system of claim 16, wherein the profile includes a referenced subreport, and wherein the operation of verifying the profile comprises detecting that the referenced subreport has become unlinked from the report.

18. The system of claim 15, wherein the profile includes a referenced data field, and wherein the operation of verifying the profile comprises detecting that the referenced data field has been dropped from the data source.

19. The system of claim 15, wherein the profile includes a referenced data parameter, and wherein the operation of verifying the profile comprises detecting that the referenced data parameter has been dropped from the data source.

20. The system of claim 15, wherein the notification is a digital watermark or a message box added to the rendering of the report.
